(19) United States
(12) Patent Application Publication
(10) Pub. No.: US 2020/0301997 A1
(43) Pub. Date: Sep. 24, 2020

(54) Fuzzy Cohorts for Provenance Chain Exploration

(71) Applicant: Microsoft Technology Licensing, LLC, Redmond, WA (US)

(72) Inventors: Matthew James SMITH, Twickenham (GB); Jayashree Siddharth DESHMUKH, London (GB); Giridharen THARMANANTHAR, Kenilworth (GB)

(73) Assignee: Microsoft Technology Licensing, LLC, Redmond, WA (US)

(21) Appl. No.: 16/361,479

(22) Filed: Mar. 22, 2019

(51) Int. Cl. G06F 17/18; G06F 17/15

(52) U.S. Cl. CPC G06F 17/18; G06F 17/15

(57) ABSTRACT

Described herein is a provenance chain exploration system and method. Particular journeys of entities are identified from stored provenance chain data using an algorithm. A group of similar journeys (representative journey) can be identified using a clustering algorithm and/or probabilistic algorithm. Information associated with the identified group of similar journeys (representative journey) can be graphically displayed to a user. The user can interactively modify setting(s) associated with identification of journeys and/or identification of group(s) of similar journeys. The graphically displayed information can be modified in accordance with the modified setting(s).

### BACKGROUND

An increasing requirement by those investigating the history behind any entity (e.g., a physical product such as a car, a digital entity such as a music file or social media news article, a person's medical history, a computer software product) is to be able to access a full provenance chain behind that entity. Provenance chains can simply be a log (e.g., data) of where and when the entity (e.g., product) was in the past. For example, provenance chains can include the history behind ingredients that led to a product's construction. Provenance chains can show additional linked data such as the country source materials were harvested from, details of sustainability audits, whether a person who modified some code had an identity (and what the identity was), and the like.

### SUMMARY

Described herein is a provenance chain exploration system, comprising: a computer comprising a processor and a memory having computer-executable instructions stored thereupon which, when executed by the processor, cause the computer to: identify particular journeys of entities from stored provenance chain data using an algorithm; cluster the identified journeys into a group of similar journeys using a clustering algorithm and a clustering threshold; graphically display information associated with the group of similar journeys to a user.

Also described herein is a method of providing graphical information for provenance chain exploration, comprising: identifying particular journeys of entities from stored provenance chain data using an algorithm; determining a group of similar journeys using a probabilistic algorithm and a threshold probability; graphically displaying information associated with the group of similar journeys to a user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a provenance chain exploration system.

FIG. 2 is an exemplary user interface.

FIG. 3 is a flow chart of a method of providing graphical information for provenance chain exploration.

FIG. 4 is a flow chart of a method of providing graphical information for provenance chain exploration.

FIG. 5 is a flow chart of a method of providing graphical information for provenance chain exploration.

FIG. 6 is a functional block diagram that illustrates an exemplary computing system.

### DETAILED DESCRIPTION

Various technologies pertaining to provenance chain exploration are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding provenance chain exploration. What follows are one or more exemplary systems and methods.

Aspects of the subject disclosure pertain to the technical problem of provenance chain exploration. The technical features associated with addressing this problem involve identifying particular journeys of entities from stored provenance chain data using an algorithm; clustering the identified journeys into a group of similar journeys using a clustering algorithm and a clustering threshold; graphically displaying information associated with the group of similar journeys to a user (sometimes referred to herein as a “representative journey”). Accordingly, aspects of these technical features exhibit technical effects of more efficiently and effectively exploring provenance chain data, for example, reducing computer resource consumption (e.g., processing and/or memory) and/or reducing bandwidth and/or reducing visual complexity for the user.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

Information can be stored in provenance chains in one or more ways, for example, a log, a database, a blockchain data structure, etc. Provenance chains can provide user(s) with powerful information about the history of an entity, component(s) of the entity, and/or information relating to the entity. However, being able to understand this information in a meaningful way can be difficult. For example, being able to trace the history of components of a particular product may be helpful for review of a single product. However, tracing the history of hundreds, thousands, hundreds of thousands of products can be overwhelming for even the most astute user. For purposes of explanation, a provenance chain can be discussed or viewed as a tree with leaf nodes comprising constituent components and intermediate nodes comprising stages leading to an entity (e.g., product) represented as the root node of the tree. A provenance chain can be either complete or partial. If it is complete then the chain represents all recorded stages or components relevant to the entity whereas a partial provenance chain only has a subset of the recorded data about the entity.

Increasingly user(s) want to be able to perform analysis of provenance chain information in a meaningful way. For example, tracing the potential sources of a contaminant found in a batch of products that were created through a complicated supply chain process, predicting how long the assembly of a particular product would take, or investigating multiple news fraud events. In such cases, where there are a large number of provenance chains, it can become overwhelmingly laborious to manage single provenance chains as a set of separate steps.

Described herein is a system and method for provenance chain exploration. A journey (also sometimes referred to as a “provenance chain”) is the graph (synonymous with network) connecting data that describes the provenance of a single product/entity. Individual journeys can be created from data by identifying a graph that connects elements of the data. Thereafter, same or sufficiently similar journeys can be clustered into group(s) of similar journeys and/or stages. Each group of same or sufficiently similar journeys can also be referred to as a “representative journey”. “Sufficiently similar” can be based, at least in part, upon user information regarding one or more criteria associated with the provenance chains (e.g., threshold(s), temporal information, and/or location information).

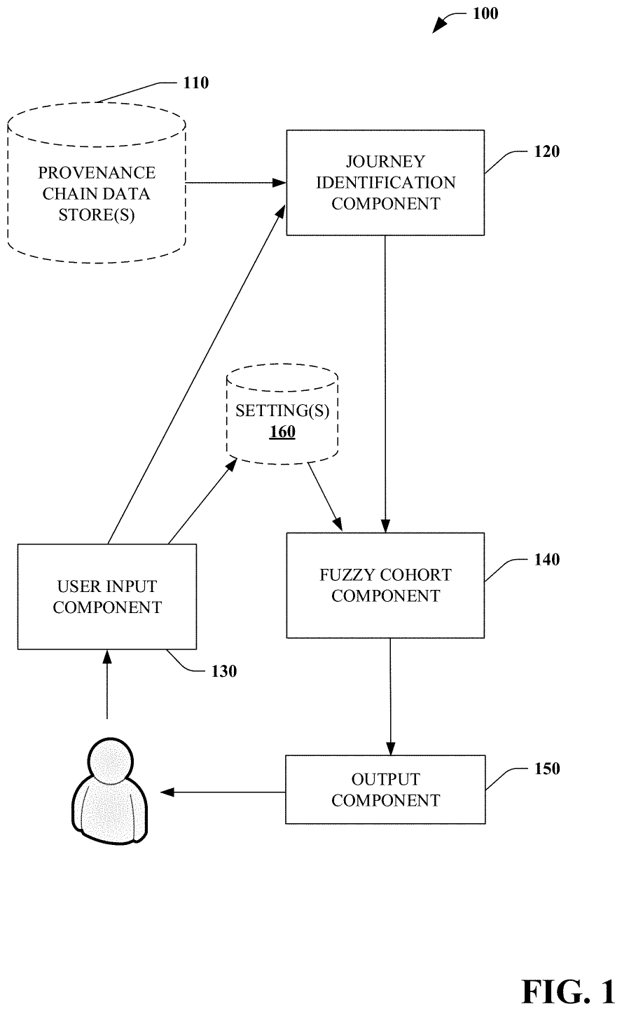

Referring to FIG. 1, a provenance chain exploration system 100 is illustrated. The system 100 allows a user to provide input (e.g., similarity threshold(s) such as clustering threshold and/or threshold probability) for clustering of identified journeys into group(s) of journeys and/or stages. Information regarding one, some or all of the identified group(s) of similar journeys and/or stages can be graphically presented to the user. In some embodiments, the system 100 can be a component of a cloud-based data analysis system with information accessible to a user via a portal.

In some embodiments, the user can dynamically interact with the identified group(s) using controls in order to interactively explore the identified group(s), stages, identified journeys, and/or underlying provenance chain data (e.g., provenance chain data representative of one or more group of similar journeys). In this manner, using the system 100 a plurality of provenance chains can be managed together as a single group (e.g., representative journey) with each group comprising journeys having identical and/or sufficiently similar provenance chains, journeys having provenance chains and/or sufficiently similar stages that are sufficiently similar to warrant being treated the same for purposes of analysis. In some embodiments, each representative journey comprises an average or other form of aggregation.

The system 100 utilizes provenance chain data stored in provenance chain data store(s) 110. The data store(s) 110 can comprise one or more databases storing data in relational database(s), graph database(s), object-oriented database(s) and the like. In some embodiments, the provenance chain data store(s) 110 further includes information relating to the provenance chain of entities (e.g., products) and other data that can be linked to that provenance chain using relational database and/or graph database conventions. In some embodiments, the data store(s) 110 are stored locally to a journey identification component 120. In some embodiments, the data store(s) 110 are stored remotely and accessible to the journey identification component 120.

The system 100 includes the journey identification component 120 that comprises an algorithm to connect provenance chains into individual journeys and provide an identifier (e.g., identification number) for those journeys. The algorithm can be performed over at least some of the data stored in the provenance chain data store(s) 110. In some embodiments, a user can specify information (e.g., setting(s)) identifying criteria for identifying journeys. For example, via a user input component 130 a user can indicate a temporal parameter (e.g., date, time, date range, and/or time range) and/or a location parameter (e.g., geospatial location, location identifier such as “factory A”). The algorithm can utilize the user specified information to identify journeys meeting that criteria.

In some embodiments, the algorithm can have variable(s) to limit the number of branches in a provenance tree. Upon completion of the algorithm, a search for a particular journey identifier returns a unique “journey” associated with an individual entity.

The system 100 further includes a fuzzy cohort component 140 that utilizes an algorithm to group similar journeys. In some embodiments, the algorithm is performed over some or all of the journeys identified by the journey identification component 120. In some embodiments, the algorithm is performed over at least some of the provenance chain data stored in the provenance chain data store(s) 110.

In some embodiments, the fuzzy cohort component 140 can renormalize provenance chain data by converting provenance details such as time and/or location details to a different scale to facilitate with grouping of journeys. For example, time can be renormalized to an arbitrary index (e.g. all times in a product journey calculated relative to the earliest time in the provenance tree).

In some embodiments, the algorithm used by the fuzzy cohort component 140 to group similar journeys can be a probabilistic algorithm that determines probabilities that particular journeys are related. That is, identified journeys exceeding a threshold probability are identified as similar. For example, a calculation may be made to infer the probability that two products following separate product journeys were in the same place at the same time. In some embodiments, the threshold probability is pre-defined. In some embodiments, the threshold probability is based upon user input and can be static and/or dynamically altered during a provenance chain viewing session.

In some embodiments, the probabilistic algorithm can include a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, and/or a Gradient Boost & Adaboost algorithm.

In some embodiments, the probabilistic algorithm can utilize weights when determining probabilities that journeys associated with entity stage(s) and/or provenance chain(s) are similar. For example, a feature of provenance chain data (e.g., temporal and/or locational) can have an associated weight, with the associated weight based on significance in determining similarity probabilities. That is, features having a higher associated weight are more significant in determining similarity probabilities and features having a lower associated weight are less significant in determining similarity probabilities. A weight of zero is indicative of the associated feature not being utilized for purposes of determining similarity probabilities.

In some embodiments, the fuzzy cohort component 140 can utilize a clustering algorithm to cluster entity stage(s) and/or provenance chain(s) into individual classes based on similarity in order to group similar journeys into a group of similar journeys. For example, the clustering algorithm can be a hierarchical algorithm, a k-means algorithm, a distribution-based algorithm, and/or a density-based algorithm. Similarity can be based upon a user-defined similarity threshold, for example, to group journeys that are 99.00% similar.

In some embodiments, the clustering algorithm can utilize weights when clustering similar entity stage(s) and/or provenance chain(s) into particular group(s). For example, a feature of provenance chain data (e.g., temporal and/or locational) can have an associated weight, with the associated weight based on significance in inferring similarities. That is, features having a higher associated weight are more significant in inferring similarities and features having a lower associated weight are less significant in inferring similarities. A weight of zero is indicative of the associated feature not being utilized for purposes of clustering.

In some embodiments, the associated weights are determined and/or adaptively modified using a machine-learning algorithm, as discussed below. In some embodiments, the associated weights are determined manually (e.g., based upon user input) statically (e.g., pre-defined) and/or dynamically (e.g., responsive to user interaction with identified group of similar journeys).

In some embodiments, the weight(s) can be determined using an algorithm initially trained using a machine learning process that utilizes various features present in datasets with the algorithm representing an association among the features. In some embodiments, the algorithm is trained using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, Artificial Neural Network (ANN), and/or a Gradient Boost & Adaboost algorithm. The algorithm can be trained in a supervised, semi-supervised and/or unsupervised manner.

The identified group of similar journeys (e.g., representative journey) can be presented (e.g., displayed) to the user via the output component 150. In some embodiments, the output component 150 further includes a graphical user interface displaying one or more controls allowing the user to interact and/or modify parameter(s) used for identifying journeys to be displayed, variable(s) to limit the number of branches in a provenance tree, similarity threshold(s), probability threshold(s), weight(s) of feature(s) for clustering, and/or weight(s) of feature(s) for determining probabilities.

For example, a user may be interested in viewing information regarding provenance chains that are substantially similar instead of only those that are exactly identical in order to better understand the data underlying the provenance chains. The difference between those that are substantially similar and those that are exactly identical can be useful to identify processing issues, potential sources of contamination, etc.

In some embodiments, the output component 150 and the user input component 130 can provide a natural way for users to vary setting(s) of the algorithm employed by the journey identification component 120 (e.g., filter setting(s) for provenance chain data store(s) 110) and/or the algorithm employed by the fuzzy cohort component (e.g., probabilistic algorithm, renormalization, and/or clustering algorithm). In some embodiments, the output component 150 and the user input component 130 can comprise control(s) (e.g., slider(s), radio button(s), drop down menu(s), data input box(es), and/or output box(es)) for generating group(s) of similar journeys. For example, the user can graphically view (e.g., interactive graphic and/or numerical feedback) an impact of changing one or more setting(s) for identifying journeys of provenance chains has on identifying group(s) of similar journeys (e.g., number of journeys comprised in a particular group of similar journeys).

In this manner, the output component 150 and the user input component 130 can allow the user to observe and/or interact with the resulting grouping of journeys represented by the identified group of similar journeys. In some embodiments, this information can be provided in one or more interface types such as a tabular list, a graphical representation of journeys, a 3D visualization, etc.

In some embodiments, the system 100 can include a setting(s) store 160. The setting(s) store 160 can include one or more settings to be used for aggregation of journeys by the probabilistic algorithm or the clustering algorithm of the fuzzy cohort component 140 into a representative journey. In some embodiments, the settings can include one or more settings pre-stored by a user. In some embodiments, the settings can include one or more commonly used settings. In some embodiments, the settings can include one or more historically utilized and saved aggregation criteria.

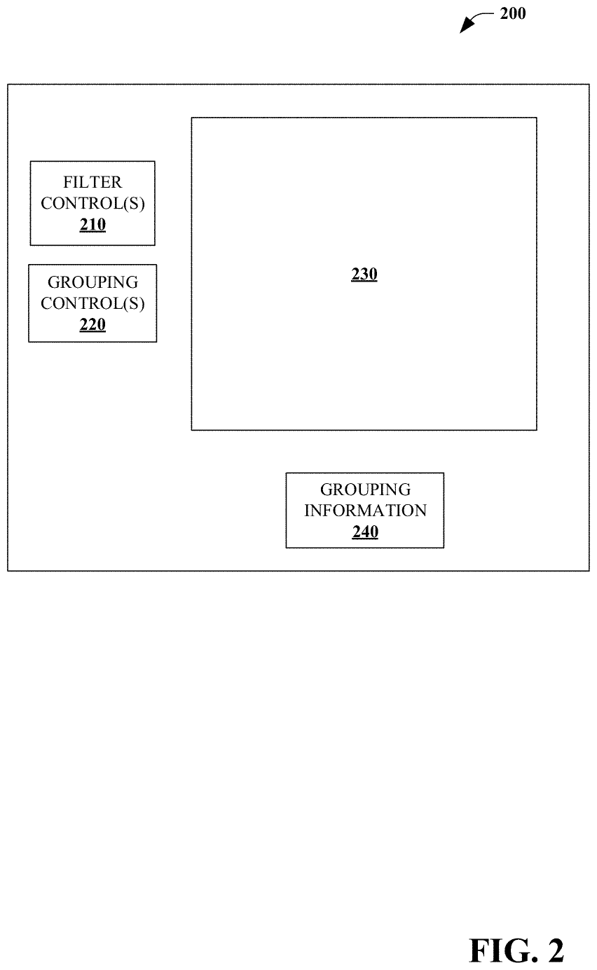

Turning to FIG. 2, an exemplary user interface 200 is illustrated. The user interface 200 can be displayed by the output component 150 and/or receive information for the user input component 130.

The user interface 200 includes zero, one or more filter controls 210 for receiving information from the user regarding filter(s) to be applied to the provenance chain data (e.g., temporal and/or locational). The user interface 200 further includes zero, one or more grouping control(s) 220 to be applied by the algorithm of the fuzzy cohort component 140 in group similar journeys (e.g., variable(s) to limit the number of branches in a provenance tree, similarity threshold(s), probability threshold(s), weight(s) of feature(s) for clustering, weight(s) of feature(s) for determining probabilities).

The user interface 200 further includes an output visualization area 230 that graphically displays information associated with the group of similar journeys to the user. The user interface 200 can further include a grouping information field 240 in which the system 100 can display numerical feedback associated with the graphically displayed information associated with the group of similar journeys.

In some embodiments, the user interface 200 can dynamically receive user input, for example, altering the filter control(s) and/or the grouping control(s). In response, the system 100 can re-calculate journey(s) and/or group(s) of journey(s) and displayed updated information in the output visualization area 230 and the grouping information field 240.

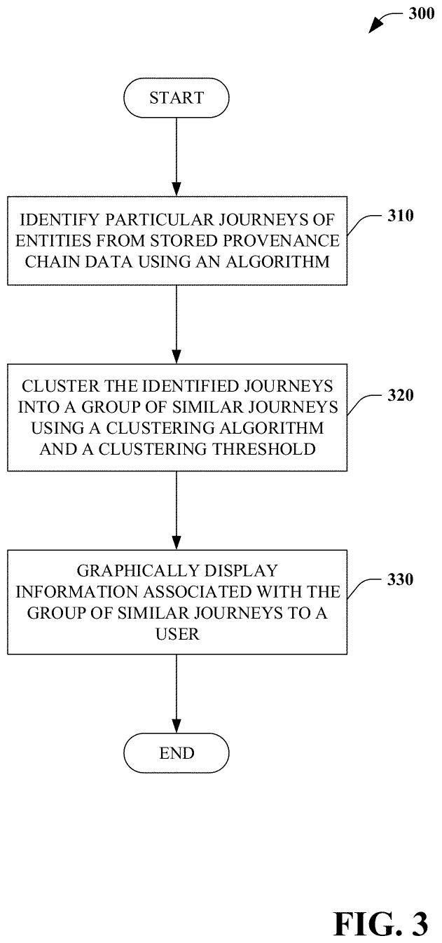

FIGS. 3-5 illustrate exemplary methodologies relating providing graphical information for provenance chain exploration. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 3, a method of providing graphical information for provenance chain exploration 300 is illustrated. In some embodiments, the method 300 is performed by the system 100.

At 310, particular journeys of entities from stored provenance chain data are identified using an algorithm. At 320, the identified journeys are clustered into a group of similar journeys (e.g., representative journey) using a clustering algorithm and a clustering threshold. At 330, information associated with the group of similar journeys is graphically displayed to a user.

In some embodiments, the method 300 can be performed iteratively in response to user input specifying at least one of a temporal, content based, or locational filter to be applied to the stored provenance chain data to identify particular journeys. In some embodiments, the method 300 can be performed iteratively in response to user input specifying the clustering threshold. In some embodiments, the method 300 can be performed iteratively in response to user input specifying weight(s) associated with features of the provenance chain data utilized by the clustering algorithm.

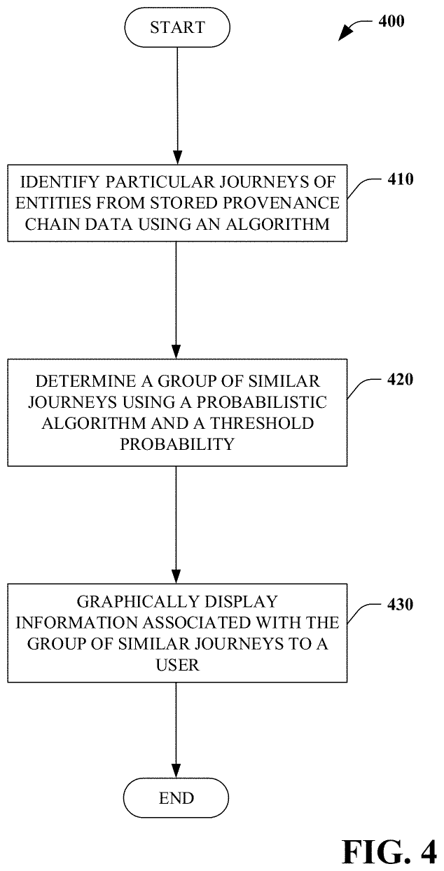

Turning to FIG. 4, a method of providing graphical information for provenance chain exploration 400 is illustrated. In some embodiments, the method 400 is performed by the system 100.

At 410, particular journeys of entities from stored provenance chain data are identified using an algorithm. At 420, a group of similar journeys (e.g., representative journey) is determined using a probabilistic algorithm and a threshold probability. At 430, information associated with the group of similar journeys is graphically displayed to a user.

In some embodiments, the method 400 can be performed iteratively in response to user input specifying at least one of a temporal or locational filter to be applied to the stored provenance chain data to identify particular journeys. In some embodiments, the method 400 can be performed iteratively in response to user input specifying the threshold probability. In some embodiments, the method 400 can be performed iteratively in response to user input specifying weight(s) associated with features of the provenance chain data utilized by the probabilistic algorithm.

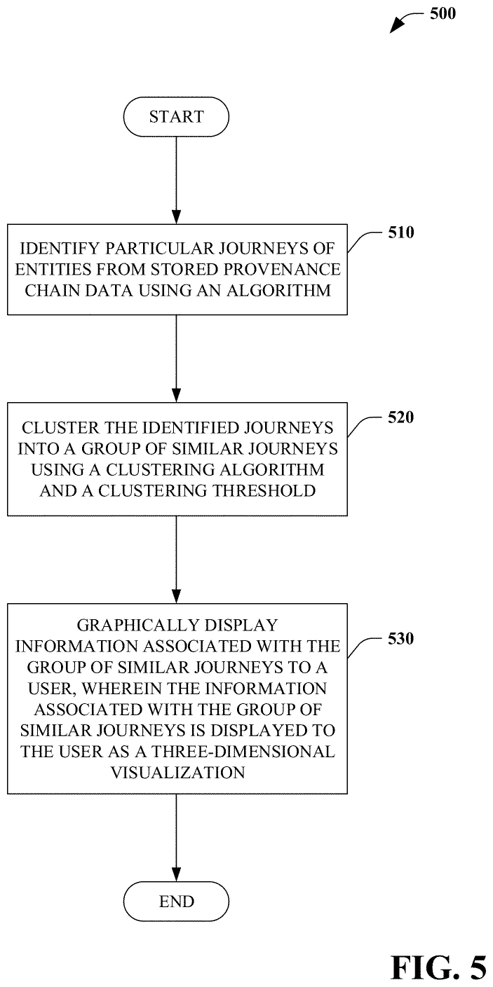

Next, referring to FIG. 5, a method of providing graphical information for provenance chain exploration 500 is illustrated. In some embodiments, the method 500 is performed by the system 100.

At 510, particular journeys of entities from stored provenance chain data are identified using an algorithm. At 520, the identified journeys are clustered into a group of similar journeys (e.g., representative journey) using a clustering algorithm and a clustering threshold. At 530, information associated with the group of similar journeys to a graphically displayed to a user. In some embodiments, the information associated with the group of similar journeys is displayed to the user as a two-dimensional visualization (e.g., time represented horizontally, space represented vertically, quantity represented by size, etc.), three-dimensional visualization, and/or multi-dimensional visualization.

In some embodiments, the method 500 can be performed iteratively in response to user input specifying at least one of a temporal or locational filter to be applied to the stored provenance chain data to identify particular journeys. In some embodiments, the method 500 can be performed iteratively in response to user input specifying the clustering threshold. In some embodiments, the method 500 can be performed iteratively in response to user input specifying weight(s) associated with features of the provenance chain data utilized by the clustering algorithm.

Described herein is a provenance chain exploration system, comprising: a computer comprising a processor and a memory having computer-executable instructions stored thereupon which, when executed by the processor, cause the computer to: identify particular journeys of entities from stored provenance chain data using an algorithm; cluster the identified journeys into a group of similar journeys using a clustering algorithm and a clustering threshold; and graphically display information associated with the group of similar journeys to a user.

The system can further include wherein the particular journeys are identified based, at least in part, upon received user input specifying at least one of a temporal, a locational filter, or a content based filter to be applied to the stored provenance chain data. The memory can have further computer-executable instructions stored thereupon which, when executed by the processor, cause the computer to: receive input from the user identifying a criterion for identifying the particular journeys.

The memory can have further computer-executable instructions stored thereupon which, when executed by the processor, cause the computer to: receive input from the user specifying the clustering threshold. The system can further include wherein the clustering algorithm comprises at least one of a hierarchical algorithm, a k-means algorithm, a distribution-based algorithm, or a density-based algorithm.

The system can further include wherein the clustering algorithm comprises weights associated with features of the provenance chain data. The system can further include wherein the at least some of the weights are based, at least in part, upon received user input. The system can further include wherein the information associated with the group of similar journeys is displayed to the user as a multi-dimensional visualization.

Described herein is a method of providing graphical information for provenance chain exploration, comprising: identifying particular journeys of entities from stored provenance chain data using an algorithm; determining a group of similar journeys using a probabilistic algorithm and a threshold probability; and graphically displaying information associated with the group of similar journeys to a user.

The method can further include wherein the particular journeys are identified based, at least in part, upon received user input specifying at least one of a temporal or locational filter to be applied to the stored provenance chain data. The method can further include: retrieving a stored setting for the probabilistic algorithm, wherein the stored setting comprises at least one of a setting pre-stored by a user, a commonly used setting, or historically utilized aggregation criteria.

The method can further include receiving input from the user specifying the threshold probability. The method can further include wherein the probabilistic algorithm comprises at least one of a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, and/or a Gradient Boost & Adaboost algorithm.

The method can further include wherein the probabilistic algorithm comprises weights associated with features of the provenance chain data. The method can further include wherein the at least some of the weights are based, at least in part, upon received user input. The method can further include wherein the information associated with one or more groups of similar journeys is displayed to the user as a three-dimensional visualization.

Described herein is a computer storage media storing computer-readable instructions that when executed cause a computing device to: identify particular journeys of entities from stored provenance chain data using an algorithm; cluster the identified journeys into a group of similar journeys using a clustering algorithm and a clustering threshold; and graphically display information associated with the group of similar journeys to a user, wherein the information associated with the group of similar journeys is displayed to the user as a three-dimensional visualization.

The computer storage media can store further computer-readable instructions that when executed cause a computing device to: receive input from the user specifying the clustering threshold. The computer storage media can further include wherein the clustering algorithm comprises at least one of a hierarchical algorithm, a k-means algorithm, a distribution-based algorithm, or a density-based algorithm. The computer storage media can further include wherein the clustering algorithm comprises weights associated with features of the provenance chain data, and, at least one of the weights is based, at least in part, upon received user input.

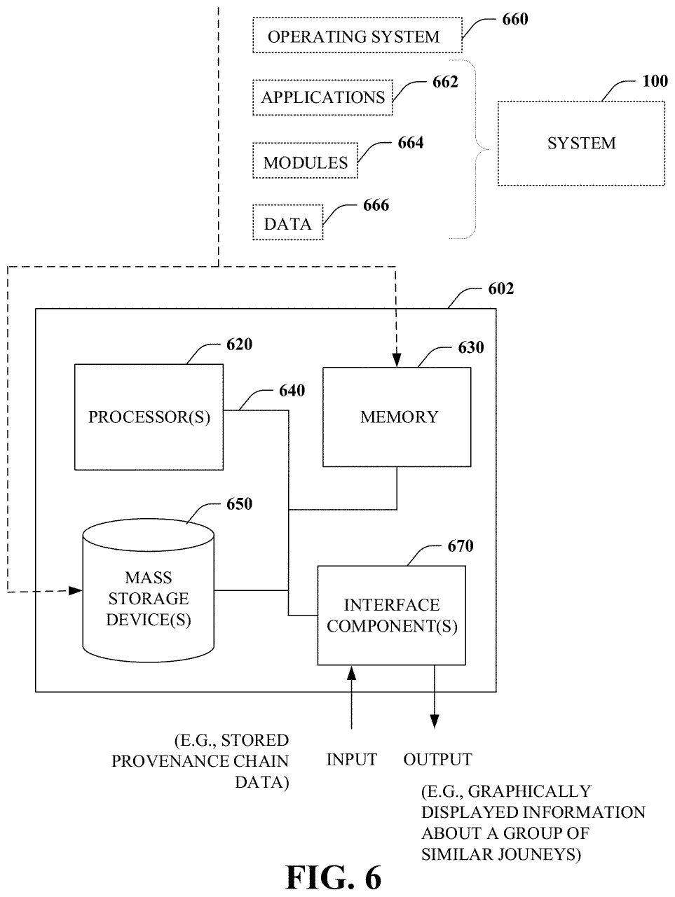

With reference to FIG. 6, illustrated is an example general-purpose computer or computing device 602 (e.g., mobile phone, desktop, laptop, tablet, watch, server, hand-held, programmable consumer or industrial electronics, set-top box, game system, compute node, etc.). For instance, the computing device 602 may be used in provenance chain exploration system 100.

The computer 602 includes one or more processor(s) 620, memory 630, system bus 640, mass storage device(s) 650, and one or more interface components 670. The system bus 640 communicatively couples at least the above system constituents. However, it is to be appreciated that in its simplest form the computer 602 can include one or more processors 620 coupled to memory 630 that execute various computer executable actions, instructions, and or components stored in memory 630. The instructions may be, for instance, instructions for implementing functionality described as being carried out by one or more components discussed above or instructions for implementing one or more of the methods described above.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 620 can be a graphics processor.

The computer 602 can include or otherwise interact with a variety of computer-readable media to facilitate control of the computer 602 to implement one or more aspects of the claimed subject matter. The computer-readable media can be any available media that can be accessed by the computer 602 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 602. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 630 and mass storage device(s) 650 are examples of computer-readable storage media. Depending on the exact configuration and type of computing device, memory 630 may be volatile (e.g., RAM), non-volatile (e.g., ROM, flash memory, etc.) or some combination of the two. By way of example, the basic input/output system (BIOS), including basic routines to transfer information between elements within the computer 602, such as during start-up, can be stored in nonvolatile memory, while volatile memory can act as external cache memory to facilitate processing by the processor(s) 620, among other things.

Mass storage device(s) 650 includes removable/non-removable, volatile/non-volatile computer storage media for storage of large amounts of data relative to the memory 630. For example, mass storage device(s) 650 includes, but is not limited to, one or more devices such as a magnetic or optical disk drive, floppy disk drive, flash memory, solid-state drive, or memory stick.

Memory 630 and mass storage device(s) 650 can include, or have stored therein, operating system 660, one or more applications 662, one or more program modules 664, and data 666. The operating system 660 acts to control and allocate resources of the computer 602. Applications 662 include one or both of system and application software and can exploit management of resources by the operating system 660 through program modules 664 and data 666 stored in memory 630 and/or mass storage device (s) 650 to perform one or more actions. Accordingly, applications 662 can turn a general-purpose computer 602 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 662, and include one or more modules 664 and data 666 stored in memory and/or mass storage device(s) 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 602 also includes one or more interface components 670 that are communicatively coupled to the system bus 640 and facilitate interaction with the computer 602. By way of example, the interface component 670 can be a port (e.g., serial, parallel, PCMCIA, USB, FireWire, etc.) or an interface card (e.g., sound, video, etc.) or the like. In one example implementation, the interface component 670 can be embodied as a user input/output interface to enable a user to enter commands and information into the computer 602, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 670 can be embodied as an output peripheral interface to supply output to displays (e.g., LCD, LED, plasma, etc.), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A provenance chain exploration system, comprising:
a computer comprising a processor and a memory having computer-executable instructions stored thereupon which, when executed by the processor, cause the computer to:
identify particular journeys of entities from stored provenance chain data using an algorithm;
cluster the identified journeys into a group of similar journeys using a clustering algorithm and a clustering threshold; and
graphically display information associated with the group of similar journeys to a user.

2. The system of claim 1, wherein the particular journeys are identified based, at least in part, upon received user input specifying at least one of a temporal, a locational filter, or a content based filter to be applied to the stored provenance chain data.

3. The system of claim 1, the memory having further computer-executable instructions stored thereupon which, when executed by the processor, cause the computer to:
receive input from the user identifying a criterion for identifying the particular journeys.

4. The system of claim 1, the memory having further computer-executable instructions stored thereupon which, when executed by the processor, cause the computer to:
receive input from the user specifying the clustering threshold.

5. The system of claim 1, wherein the clustering algorithm comprises at least one of a hierarchical algorithm, a k-means algorithm, a distribution-based algorithm, or a density-based algorithm.

6. The system of claim 1, wherein the clustering algorithm comprises weights associated with features of the provenance chain data.

7. The system of claim 6, wherein the at least some of the weights are based, at least in part, upon received user input.

8. The system of claim 1, wherein the information associated with the group of similar journeys is displayed to the user as a multi-dimensional visualization.

9. A method of providing graphical information for provenance chain exploration, comprising:
identifying particular journeys of entities from stored provenance chain data using an algorithm;
determining a group of similar journeys using a probabilistic algorithm and a threshold probability; and
graphically displaying information associated with the group of similar journeys to a user.

10. The method of claim 9, wherein the particular journeys are identified based, at least in part, upon received user input specifying at least one of a temporal or locational filter to be applied to the stored provenance chain data.

11. The method of claim 9, further comprising:
retrieving a stored setting for the probabilistic algorithm, wherein the stored setting comprises at least one of a setting pre-stored by a user, a commonly used setting, or historically utilized aggregation criteria.

12. The method of claim 9, further comprising:
receiving input from the user specifying the threshold probability.

13. The method of claim 9, wherein the probabilistic algorithm comprises at least one of a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, and/or a Gradient Boost & Adaboost algorithm.

14. The method of claim 9, wherein the probabilistic algorithm comprises weights associated with features of the provenance chain data.

15. The method of claim 14, wherein the at least some of the weights are based, at least in part, upon received user input.

16. The method of claim 9, wherein the information associated with one or more groups of similar journeys is displayed to the user as a three-dimensional visualization.

17. A computer storage media storing computer-readable instructions that when executed cause a computing device to:
identify particular journeys of entities from stored provenance chain data using an algorithm;
cluster the identified journeys into a group of similar journeys using a clustering algorithm and a clustering threshold; and
graphically display information associated with the group of similar journeys to a user, wherein the information associated with the group of similar journeys is displayed to the user as a three-dimensional visualization.

18. The computer storage media of claim 17, storing further computer-readable instructions that when executed cause a computing device to:
receive input from the user specifying the clustering threshold.

19. The computer storage media of claim 17, wherein the clustering algorithm comprises at least one of a hierarchical algorithm, a k-means algorithm, a distribution-based algorithm, or a density-based algorithm.

20. The computer storage media of claim 17, wherein the clustering algorithm comprises weights associated with features of the provenance chain data, and, at least one of the weights is based, at least in part, upon received user input.
